(19) United States
(12) Patent Application Publication
(10) Pub. No.: US 2003/0088477 A1
(43) Pub. Date: May 8, 2003

(54) Method of selling product online and computer product

(75) Inventors: Tetsushi Kobayashi, Tokyo (JP); Toshihiko Oda, Tokyo (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/083,488

(22) Filed: Feb. 27, 2002

(30) Foreign Application Priority Data
Nov. 6, 2001 (JP) 2001-340808

(51) Int. Cl. G06F 17/60

(52) U.S. Cl. 705/26

(57) ABSTRACT

Information regarding non-sellable products for each store is stored in a database. The non-sellable product is a product that cannot be sold at that particular store. If a purchaser selects a non-sellable product from a catalog of a store, then the purchaser is introduced to another store in which the same product is a sellable product.

### FIELD OF THE INVENTION

The present invention relates to a method of selling products online at a plurality of stores based on a product catalog formed from information on a plurality of products. More particularly, this invention relates to increasing the convenience for a purchaser and increase sales of products.

### BACKGROUND OF THE INVENTION

FIG. 28 is a block diagram which shows the structure of a conventional product sales system. As shown in FIG. 28, a product catalog server 10 is connected to a network 20. The product catalog server 10 provides a plurality of consumers on the network 20 with a product catalog, which is a collection of product release information from the respective manufacturers about a plurality of products, via a product catalog site 11.

A product catalog information database 12 stores product catalog information consisting of the product identification number, product name, manufacturer name, manufacturer code, price, date of sale, and the like for the plurality of products making up the product catalog.

Each one of store servers 30₁ to 30ₙ is operated by stores A to N. Products advertised in the product catalog are sold to consumers via store sites 31₁ to 31ₙ. The stores A to N are independent stores that do not belong to the same management organization and are partner stores in the product catalog site 11.

A point that needs to be noted is that not all the products advertised in the product catalog are always kept in stock in all of the stores A to N. Namely, the product catalog is created based on product release information provided by a plurality of manufacturers regardless of whether or not a particular store has dealings with a particular manufacturer.

Therefore, a state in which a store has no stock of the product of a manufacturer with which the store has no dealings frequently arises. Because of this, a state arises in which a particular product can be sold by one store (because the product is held in stock), while the same product cannot be sold by another store (because the product is not held in stock).

Each of the consumer clients 40₁ to 40ₘ is connected to the network 200 and is located on the side of the m number of consumers. Each of the consumer clients 40₁ to 40ₘ is used to purchase products online from any one of the stores A to N, via any one of the store sites 31₁ to 31ₙ and the product catalog site 11.

In the above described structure, if the consumer client 40₁ accesses the store server 30₁ (i.e., the store site 31₁), the store server 30₁ displays on the consumer client 40₁ the search menu screen 50 shown in FIG. 29. Here, if “product search” is clicked on the search menu screen 50, the store server 30₁ causes the link destination of the consumer client 40₁ to jump to the product catalog site 11.

As a result, the product catalog server 10 displays the search screen 51 (a specific example of this is the search screen 59 shown in FIG. 30) on the consumer client 40₁. This search screen 51 is used to search a product catalog information database 12 (i.e., a product catalog) using the product name or the like as a search key. When a search button 52 is pressed after a search key has been input, the product catalog server 10 searches the product catalog information database 12 on the basis of the search key, and displays a search result screen 53 (a specific example of this is the search result screen 60 shown in FIG. 30) on the consumer client 40₁.

A list of products (product A, product B, and product C) is displayed as a result of the search on the search result screen 53. If a product being ordered is selected by the consumer from among the list of products, the product catalog server 10 displays an order screen 54 (a specific example of which is the order screen 61 shown in FIG. 30) on the consumer client 40₁. This order screen 54 is used to order selected products.

When the order button 55 is pressed, the product catalog server 10 makes an enquiry to the store server 30₁ as to whether or not the relevant product is kept in stock by the store A. If the product is kept in stock, a purchase screen 56 (a specific example of which is the purchase screen 62 shown in FIG. 30) is displayed on the consumer client 40₁. The purchase screen 56 is used for the actual online purchase of the product.

If the purchase button 57 is pressed, the product catalog server 10 notifies the store site 31₁ of the consumer information and information on the product being purchased. As a result, processing to receive payment of the purchase fee and processing to deliver the product are performed in the store A.

If, however, the product ordered on the order screen 54 is not kept in stock by the store A, the product catalog server displays a not in stock screen 58 (a specific example of which is the not in stock screen 63 shown in FIG. 30) that includes an apology for the fact that the product is not kept in stock on the consumer client 40₁. Consequently, after confirming that the product cannot be obtained from the store A, the consumer begins the search again so as to make the purchase by another route by accessing another store server.

As has been described above, in a conventional product sales system, not all of the products corresponding to product catalog information database 12 shown in FIG. 28 can be sold by all of the stores A to N.

Therefore, when a product is not held in stock at a particular store, even if the consumer goes ahead and makes an order on the order screen 54 shown in FIG. 29, the purchase cannot be made and the not in stock screen 58 is displayed. Therefore, the problems arise of many claims being made by purchasers and of this purchasing system not being convenient for purchasers.

Because the store is also losing out on an excellent sales opportunity, this system is extremely disadvantageous from the viewpoint of a plurality of stores as it does nothing to promote increased product sales.

It is an object of this invention to provide a method of selling product and a computer product that increase the convenience for a purchaser and increase sales of products.

### SUMMARY OF THE INVENTION

According to one aspect of the present invention, products are sold online by a plurality of stores based on a product catalog that comprises information on a plurality of products. Information regarding non-sellable products for each store is managed. The non-sellable product is a product that cannot be sold (for example, because it is sold out) at that particular store. If a purchaser selects a product that is non-sellable in one store then the purchaser is introduced to another store in which that product is a sellable product.

According to another aspect of the present invention, products are sold online by a plurality of stores based on a product catalog that comprises information on a plurality of products. Information regarding non-sellable products for each store is managed. The non-sellable product is a product that cannot be sold (for example, because it is sold out) at that particular store. If a purchaser selects a product that is non-sellable in one store then that product is shipped from another store in which that product is a sellable product.

Other objects and features of this invention will become apparent from the following description with reference to the accompanying drawings.

### BRIEF DESCRIPTION OF THE DRAWINGS

FIG. 1 is a block diagram which shows the structure of one embodiment of the present invention,

FIG. 2 is a view which shows the table structure of the store information database 120 shown in FIG. 1,

FIG. 3 is a view which shows the table structure of the consumer information database 130 shown in FIG. 1,

FIG. 4 is a view which shows the table structure of the product catalog information database 140 shown in FIG. 1,

FIG. 5 is a view which shows the table structure of the non-sellable product information database 150 shown in FIG. 1,

FIG. 6 is a view which shows the table structure of the stock shortage product information database 160 shown in FIG. 1,

FIG. 7 is a view which shows the table structure of the introduction information database 170 shown in FIG. 1,

FIG. 8 is a flow chart which explains the operation of the product catalog server 100 shown in FIG. 1,

FIG. 9 is a flow chart which explains the non-sellable product information and stock shortage product information registration processing shown in FIG. 8,

FIG. 10 is a flow chart which explains the product purchase processing shown in FIG. 8,

FIG. 11 is a flow chart which explains the order processing from the host outlet shown in FIG. 10,

FIG. 12 is a flow chart which explains the manufacturer order/other store order processing shown in FIG. 10,

FIG. 13 is a flowchart which explains the introduction fee payment processing shown in FIG. 8,

FIG. 14 is a flow chart which explains the operation of the store servers 300₁ to 300ₙ shown in FIG. 1,

FIG. 15 is a flow chart which explains consumer information registration processing shown in FIG. 14,

FIG. 16 is a view which shows other store non-sellable product list screen 500 according to one embodiment,

FIG. 17 is a view which shows the search menu screen 600 in one embodiment,

FIG. 18 is a view which shows the search screen 700 in one embodiment,

FIG. 19 is a view which shows the search result screen 800 in one embodiment,

FIG. 20 is a view which shows the screen 900 which orders from this outlet in one embodiment,

FIG. 21 is a view which shows the screen 1000 which orders from the host outlet in one embodiment,

FIG. 22 is a view which shows the delivery information input screen 1100 in one embodiment,

FIG. 23 is a view which shows the manufacturer order/other store order selection screen 1200 in one embodiment,

FIG. 24 is a view which shows the store list screen 1300 in one embodiment,

FIG. 25 is a view which shows the other store purchase screen 1400 in one embodiment,

FIG. 26 is a view which shows the other store order screen 1500 in one embodiment,

FIG. 27 is a block diagram which shows the structure of a variant example of one embodiment,

FIG. 28 is a block diagram which shows the structure of a conventional product sales system,

FIG. 29 is a view which shows the screen transitions in a conventional product sales system, and

FIG. 30 is a view which shows the screen transitions in a conventional product sales system.

### DETAILED DESCRIPTIONS

An embodiment of the method of selling product and the computer product of the present invention will now be described in detail with reference to the accompanying drawings.

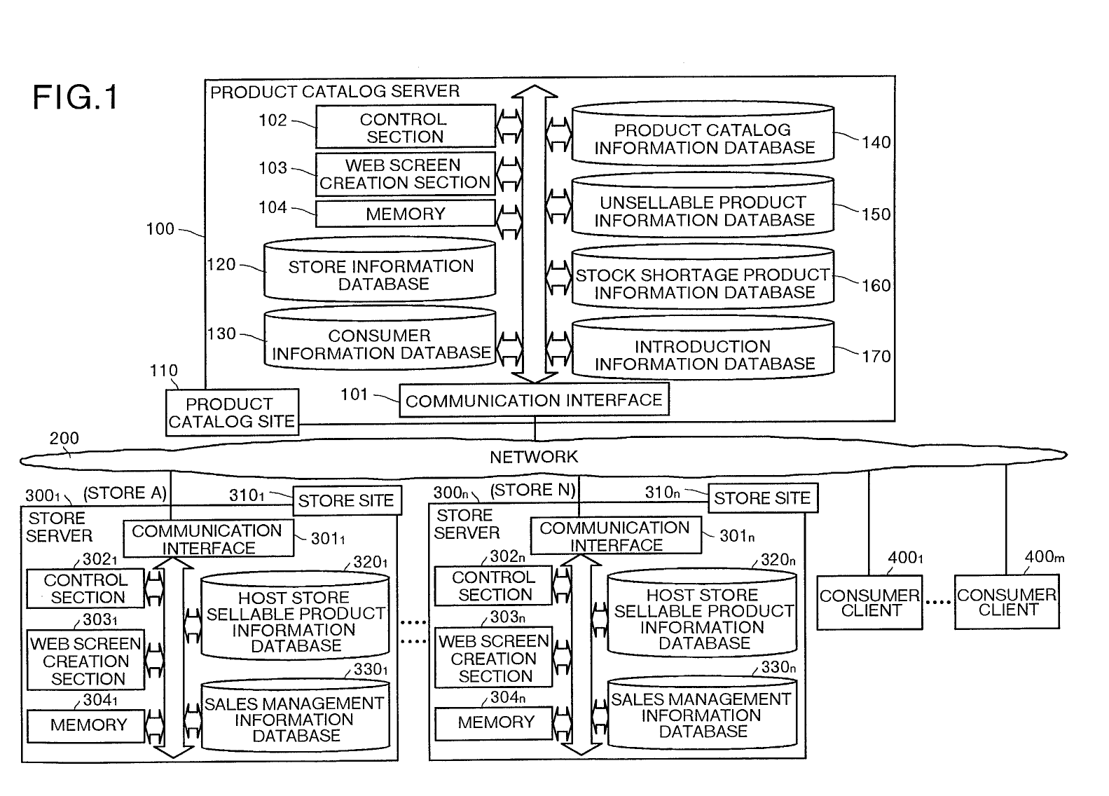

FIG. 1 is a block diagram which shows the structure of one embodiment of the present invention. As shown in FIG. 1, a product catalog server 100 is connected to a network 200. The product catalog server 100 provides a plurality of consumers on the network 200 with a product catalog, which is a collection of product release information from the respective manufacturers about a plurality of products, via a product catalog site 110. The product catalog server 100 also manages store information, consumer information, product catalog information, non-sellable product information, stock shortage product information, and introduction information, which are described below.

In the product catalog server 100, a communication interface 101 controls communication between the product catalog server 100 and outside devices via the network 200 in accordance with a predetermined communication protocol. A control section 102 controls each section. The operation of this control section 102 is described in detail below. A Web screen creation section 103 creates the various types of screen described below. Memory 104 temporarily stores the various types of data.

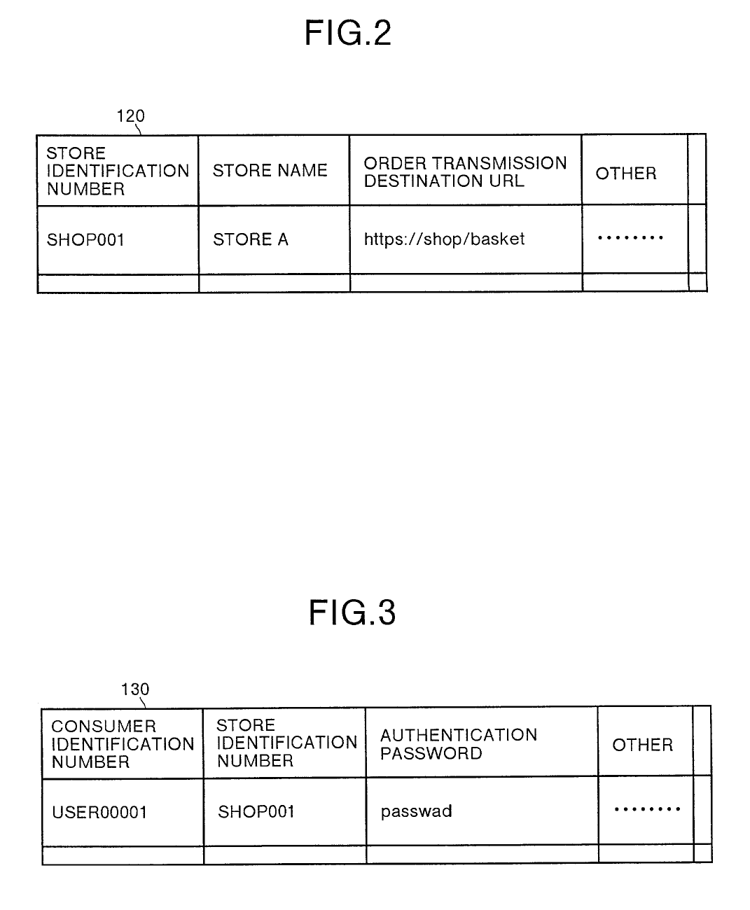

A store information database 120 stores store information that relates to the stores A to N that sell products online using a product catalog. Specifically, as is shown in FIG. 2, the store information database 120 is provided with fields such as “store identification number”, “store name”, “order transmission destination URL (uniform resource locator)”, and “other”.

The “store identification number” is used to identify the respective stores A to N. The “store name” is the name of the respective stores A to N. “Order transmission destination URL” is the URL used when transmitting order information and the like from the product catalog server 100 when a product is ordered by a consumer. “Other” is all other types of information. The stores A to N are independent stores that do not belong to the same management organization and are partner stores in the product catalog site 110.

Returning to FIG. 1, consumer information database 130 stores consumer information that relates to consumers who have been registered as members via the store site. Specifically, as is shown in FIG. 3, the consumer information database 130 is provided with fields such as “consumer identification number”, store identification number”, “authentication password”, and “other”.

The “consumer identification number” is used to identify the consumer. The “store identification number” corresponds to the “store identification number” shown in FIG. 2 and is used to identify the store where the consumer performed the member registration. The “authentication password” is used to authenticate whether or not the consumer is a member. “Other” is all other types of information.

Returning to FIG. 1, the product catalog information database 140 stores product catalog information consisting of the product identification number, product name, manufacturer name, manufacturer code, price, date of sale, and the like for the plurality of products making up the product catalog.

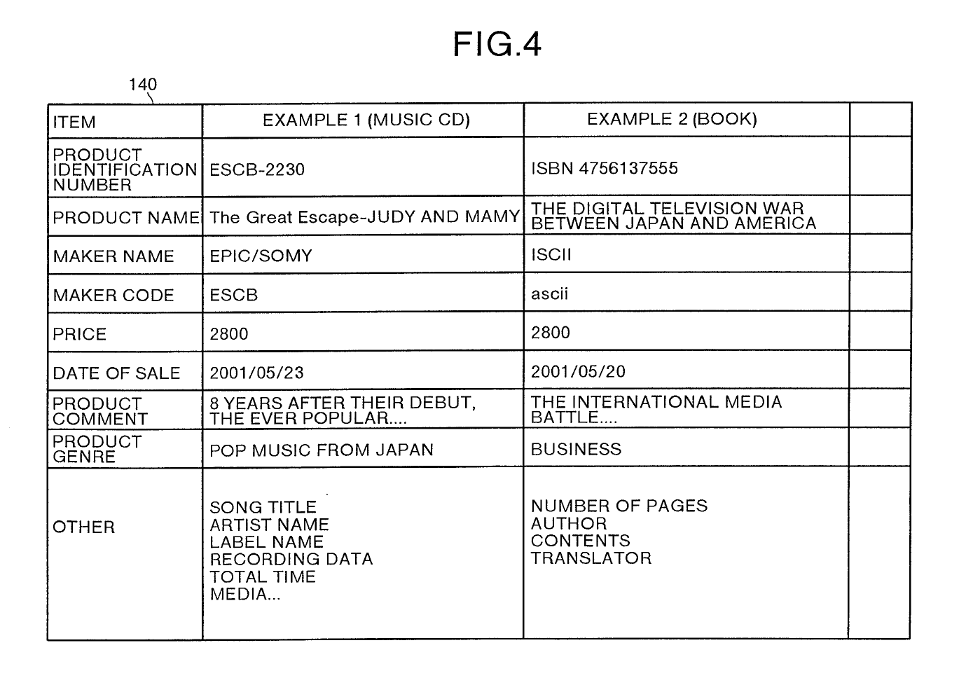

Specifically, as is shown in FIG. 4, the product catalog information database 140 is provided with fields such as “product identification number”, “product name”, “manufacturer name”, manufacturer code”, “price”, “date of sale”, “product comment”, “product genre”, and “other”. The “product identification number” is used to identify a product. The “product name” is the name of the product. “Maker name” is the name of the manufacturer manufacturing the relevant product. “Price” is the sale price of the product at the store. “Date on sale” is the date the product went on sale. “Product comment” contains comments about the product. “Product genre” is the genre to which the product belongs. “Other” is detailed information (e.g., song names, artist names, etc) on the product.

A point that needs to be noted is that not all the products advertised in the product catalog are always kept in stock in all of the stores A to N. Accordingly, in the same way as in a conventional system, a state in which a store has no stock of the product of a manufacturer with which the store has no dealings frequently arises. However, in one embodiment, as is described below, by introducing the consumer to another store or placing an order with the manufacturer when the product is not kept in stock by the first store, the consumer is provided with an opportunity to purchase the product by another method.

Returning to FIG. 1, the non-sellable product information database 150 stores non-sellable product information that relates to products that cannot be sold (because they are not kept in stock) by the host store from among the plurality of products advertised in the product catalog for each of the stores A to N.

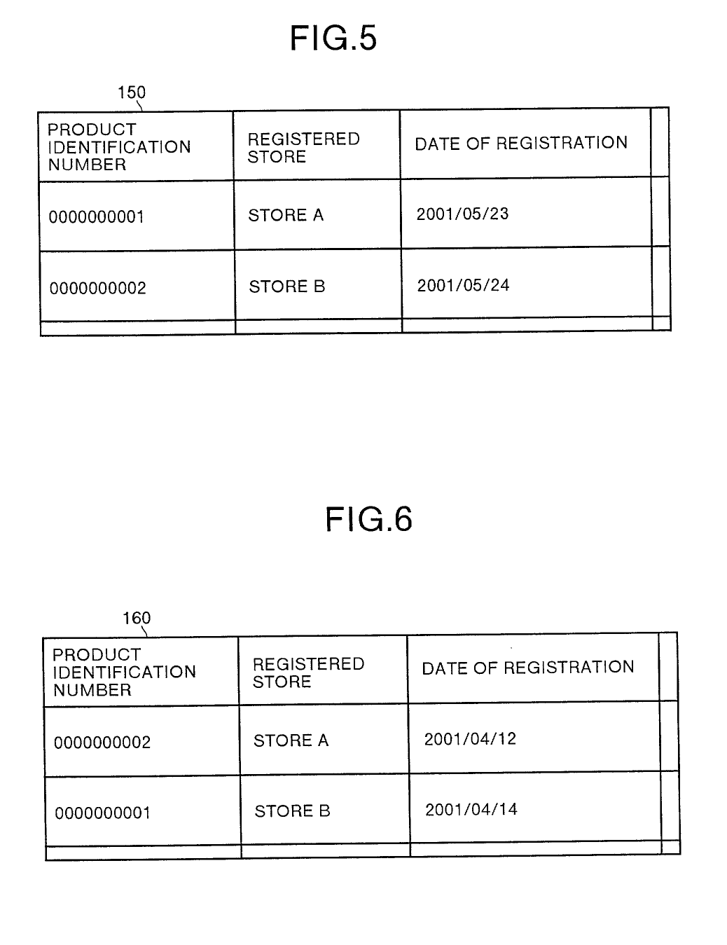

Specifically, as is shown in FIG. 5, the non-sellable product information database 150 is provided with fields such as “product identification number”, “registered store”, and “date of registration”. The “product identification number is used to identify products that cannot be sold by the relevant store. “Registered stores” are the name of those stores that can sell the product. “Date of registration” is the date the non-sellable product information is registered in the non-sellable product information database 150.

Returning to FIG. 1, a stock shortage product information database 160 stores stock shortage product information that relates to a product of which there is a shortage of stock (referred to below as a stock shortage product). Shortage of stock refers to a state in each of the stores A to N in which the host store can sell the product (i.e. keeps the product in stock), while other stores cannot sell the product (i.e., do not keep the product in stock). However, there are cases, caused by differences in the times stock shortage product information is registered in the stock shortage product information database 160, in which the same product can be sold by a plurality of stores.

Specifically, as is shown in FIG. 6, the stock shortage product information database 160 is provided with fields such as “product identification number”, “registered store”, and “date of registration”. The “product identification number” is used to identify a stock shortage product. “Registered stores” are the names of those stores that can sell a stock shortage product. “Date of registration” is the date when the stock shortage product information is registered in the stock shortage product information database 160.

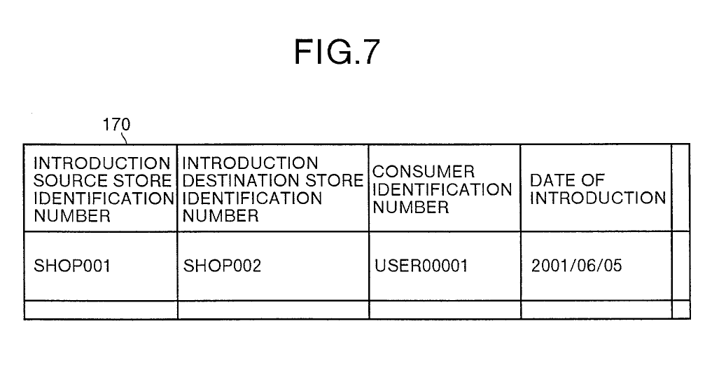

Returning to FIG. 1, an introduction information database 170 stores introduction information that relates to the introduction when a consumer is introduced to another store that can sell a particular product and the product is purchased at the other store when the product cannot be sold (because it is not kept in stock) at the host store. Specifically, as is shown in FIG. 7, the introduction information database 170 is provided with fields such as “introduction source store identification number”, “introduction destination store identification number”, consumer identification number”, and “date of introduction”.

The “introduction source store identification number” is the name of the store (i.e., the host store itself) that is introducing the consumer. “Introduction destination store identification number” is the name of the store (i.e., another store) to which the consumer is being introduced. “Consumer identification number” is used to identify the consumer being introduced. “Date of introduction” is the date the consumer is introduced.

Returning to FIG. 1, the respective store servers 300₁ to 300ₙ are operated by the stores A to N. Products advertised in the product catalog are sold to consumers via the store sites 310₁ to 310ₙ. The stores A to N are partner stores in the product catalog site 110.

In the product catalog server 300₁, a communication interface 301₁ controls communication between the product catalog server 300₁ and outside devices via the network 200 in accordance with a predetermined communication protocol. A control section 302₁ controls each section. The operation of this control section 302₁ is described in detail below. A Web screen creation section 303₁ creates the various types of screen described below. Memory 304₁ temporarily stores the various types of data.

A host store sellable product information database 320₁ stores host store sellable product information (e.g., a product identification number which identifies the product, the date of registration, and the like) that relates to products that can be sold (i.e., that are kept in stock) by the host store itself (i.e., by the store A). A sales management information database 330₁ stores sales management information (consumer information, turnover information, and the like) in the store A.

In the store server 300ₙ, a communication interface 301ₙ controls communication between the store server 300ₙ and outside devices via the network 200 in accordance with a predetermined communication protocol. A control section 302ₙ controls each section. The operation of this control section 302ₙ is described in detail below. A Web screen creation section 303ₙ creates the various types of screen described below. Memory 304ₙ temporarily stores the various types of data.

A host store sellable product information database 320ₙ stores host store sellable product information (e.g., a product identification number which identifies the product, the date of registration, and the like) that relates to products that can be sold (i.e., that are kept in stock) by the host store itself (i.e., by the store N). A sales management information database 330ₙ stores sales management information (consumer information, turnover information, and the like) in the store N.

Each of the consumer clients 400₁ to 400ₘ is connected to the network 200 and is located on the side of the m number of consumers. Each of the consumer clients 400₁ to 400ₘ is used to purchase products online from any of the stores A to N, via one of the store sites 310₁ to 310ₙ and the product catalog site 110.

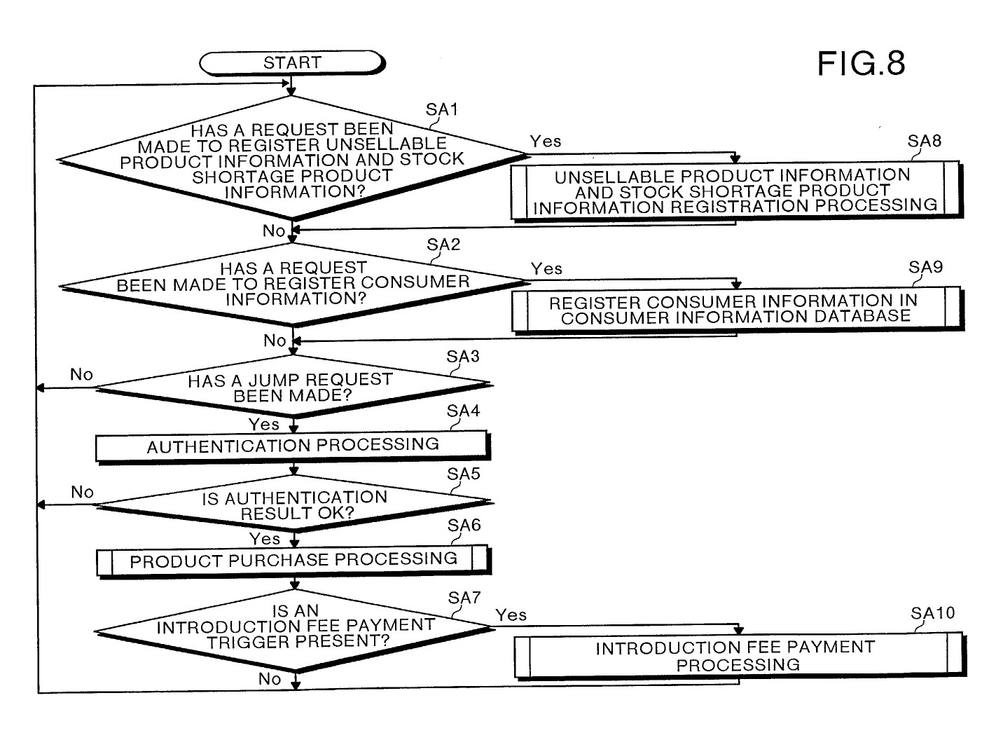

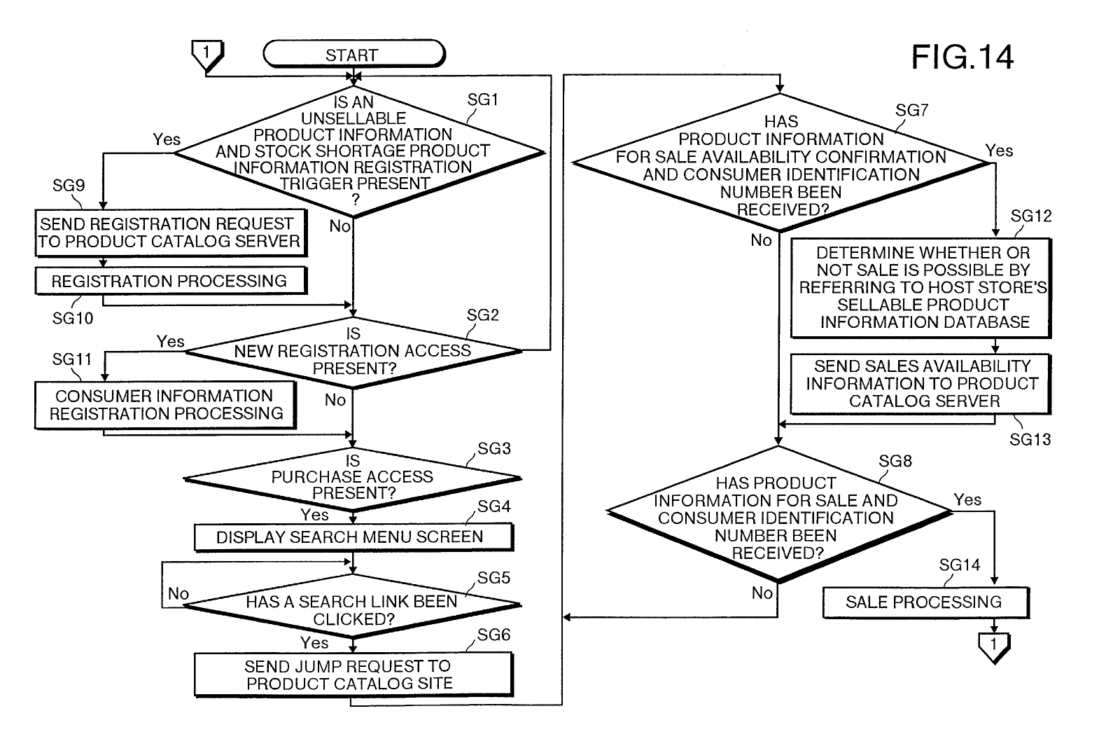

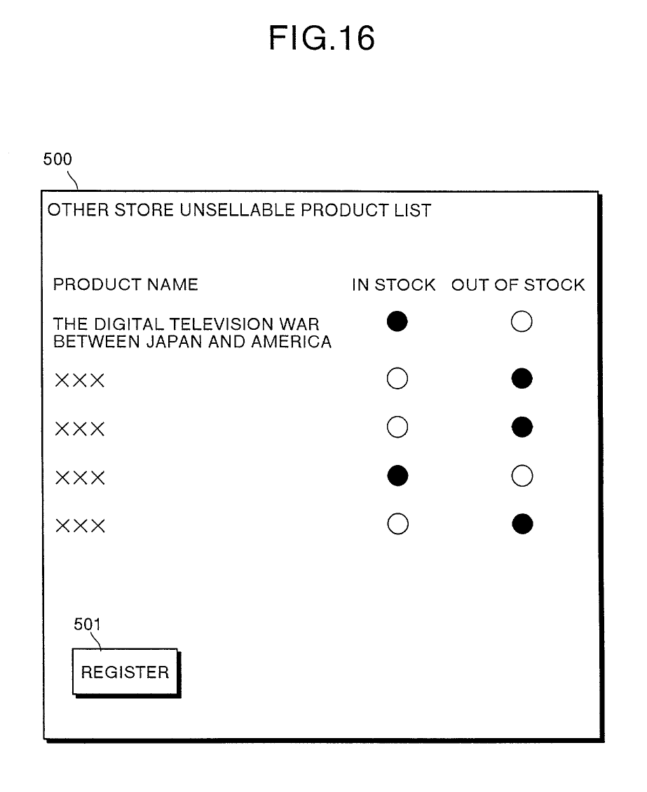

The operation of one embodiment will now be described. The description is given with reference to the flow charts shown in FIGS. 8 to 15 and the various screens shown in FIGS. 16 to 26. FIG. 8 is a flow chart explaining the operation of the product catalog server 100 shown in FIG. 1. FIG. 14 is a flow chart explaining the operation of the store servers 300₁ to 300ₙ shown in FIG. 1.

At step SA1 shown in FIG. 8, the control section 102 of the product catalog server 100 determines whether or not a request to register non-sellable product information and stock shortage product information in the non-sellable product information database 150 and the stock shortage product information database 160 has been made from any of the store servers 330₁ to 300ₙ. In this case, the result of the determination will be taken as NO.

At step SA2, the control section 102 determines whether or not a request to register consumer information in the consumer information database 130 has been made from any of the store servers 300₁ to 300ₙ. In this case, the result of the determination will be taken as NO.

At step SA3, the control section 102 determines whether or not a jump request to jump from a store site (described below) to the product catalog site 110 has been made from any of the store servers 300₁ to 300ₙ. In this case, the result of the determination will be taken as NO. Thereafter, the control section 102 repeats the determinations of steps SA1 to SA3.

At step SG1 shown in FIG. 14, the control section 302₁ of the store server 300₁ determines whether or not a registration trigger to register non-sellable product information and stock shortage product information in the non-sellable product information database 150 and the stock shortage product information database 160 is present. In this case, the result of the determination will be taken as NO. Examples of this registration trigger include those based on an instruction from an operator and those based on timer settings.

At step SG2, the control section 302₁ determines whether or not a new registration access relating to the member registration of a consumer has been made from any of the consumer clients 400₁ to 400ₘ. In this case, the result of the determination will be taken as NO.

At step SG3, the control section 302₁ determines whether or not a purchase access has been made from any of the consumer clients 400₁ to 400ₘ in order to purchase a product via the store site 310₁ and the product catalog site 110. In this case, the result of the determination will be taken as NO. Thereafter, the control section 302₁ repeats the determinations of steps SG1 to SG3. Note that the other store servers 300₂ (not shown) to 300ₙ perform the same operations as the above described store server 300₁.

If a registration trigger to register non-sellable product information and stock shortage product information is present due to an instruction from an operator of the store A, the result of the determination by the control section 302₁ of the store server 300₁ at step SG1 is YES. At step SG9, the control section 302₁ sends a registration request to the product catalog server 100. As a result, the result of the determination at step SA1 in FIG. 8 by the control section 102 of the product catalog server 100 is YES. At step SA8, the control section 102 performs non-sellable product information and stock shortage information registration processing to register non-sellable product information and stock shortage information relating to store A in the non-sellable product information database 150 and the stock shortage information database 160.

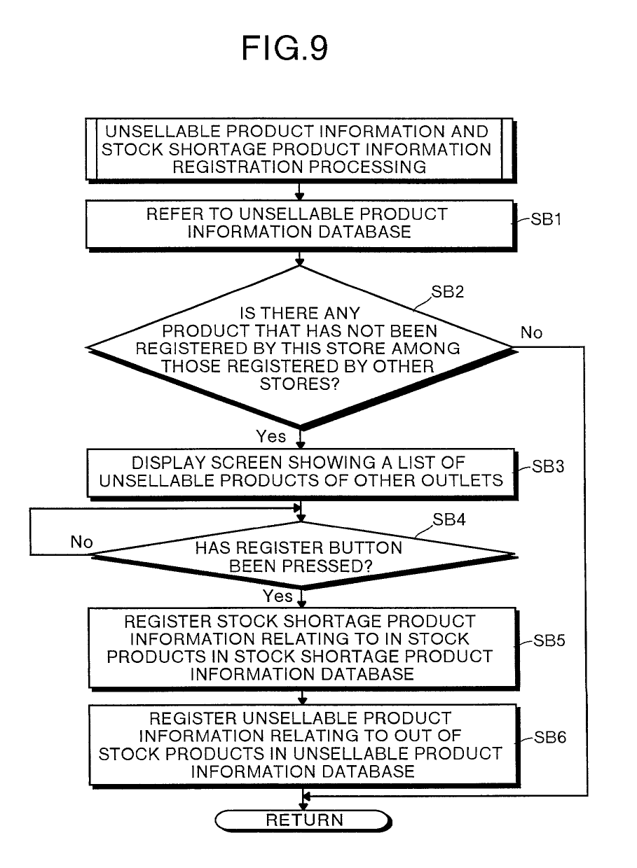

Specifically, at step SB1 shown in FIG. 9, the control section 102 refers to the non-sellable product information database 150 shown in FIG. 5. At step SB2, the control section 102 determines whether or not any product not registered by the host store is among the products that have been registered in the non-sellable product information database 150 by other stores (referred to below as “other store non-sellable products”). If the result of this determination is NO, the processing returns to the main routine shown in FIG. 8.

If, however, the result of the determination at step SB2 is YES, then, at step SB3, the control section102 acquires product names relating to the other store non-sellable products from the product catalog information database 140 using the product identification numbers (i.e., the non-sellable product information database 150 (see FIG. 5)) corresponding to the other store non-sellable products as a key.

The control section 102 displays the other store non-sellable product list screen 500 shown in FIG. 16 on the display (not shown) of the store server 300₁ based on the acquired product names. The other store non-sellable product list screen 500 is a screen which shows a list of products that other stores cannot sell and is used to check whether or not an other store non-sellable product is kept in stock by the host store itself (in this case, the store A) At step SB4, the control section 102 determines whether or not a register button 501 has been pressed. In this case, the result of the determination will be taken as NO, and the same determination is repeated.

When the other store non-sellable product list screen 500 is displayed, at step SG10, shown in FIG. 14, the operator of the store A performs the registration processing. Specifically, the operator checks the existence of stock and absence of stock on the other store non-sellable product list screen 500 (see FIG. 16) while referring to the host store sellable product information database 3201. The operator then presses the register button 501. In one embodiment, it is also possible for the check to be performed automatically by the control section 302₁.

When the register button 501 is pressed, the result of the determination at step SB4 shown in FIG. 9 by the control section 102 of the product catalog server 100 is YES. At step SB5, the control section 102 links stock shortage product information relating to products that have been checked as being in stock on the other store non-sellable product list screen 500 shown in FIG. 16 to the store A, and registers this stock shortage product information in the stock shortage product information database 160 (see FIG. 6).

At step SB6, the control section 102 links non-sellable product information relating to products that have been checked as not being in stock on the other store non-sellable product list screen 500 shown in FIG. 16 to the store A, and registers this non-sellable product information in the non-sellable product information database 150 (see FIG. 5).

If, for example, a new registration access is made from the consumer client 400₁ to the store server 300₁, the result of the determination at step SG2 shown in FIG. 14 by the control section 302₁ of the store server 300₁ is YES. At step SG11, the control section 302₁ performs consumer information registration processing to register the consumer information of the consumer who corresponds to the consumer client 400₁ in the consumer information database 130.

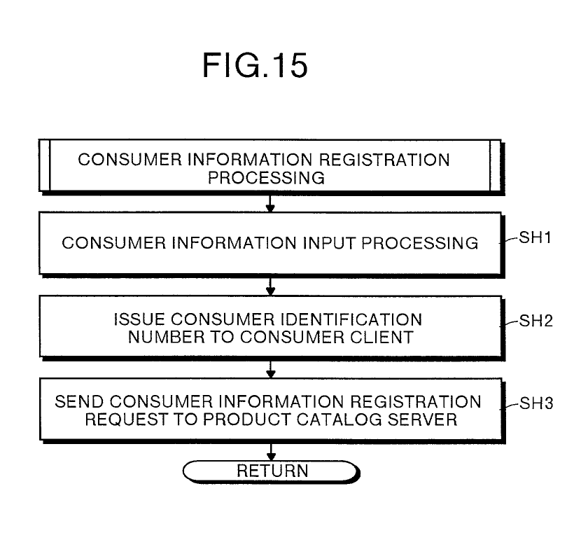

Specifically, at step SH1 shown in FIG. 15, the control section 302₁ executes consumer information input processing to receive the input of consumer information (authentication password, name, address, and the like) by the consumer using a consumer information input screen (not shown). At step SH2, the control section 302₁ issues a consumer identification number to the consumer client 400₁. At step SH3, the control section 302₁ sends a registration request to the product catalog server 100 to register the consumer information with the store identification number added thereto and also stores the consumer information in the sales management information database 330₁.

As a result, the result of the determination by the control section 102 of the product catalog server 100 at step SA2 shown in FIG. 8 is YES. At step SA9, the control section 102 registers the consumer information in the consumer information database 130 (see FIG. 3).

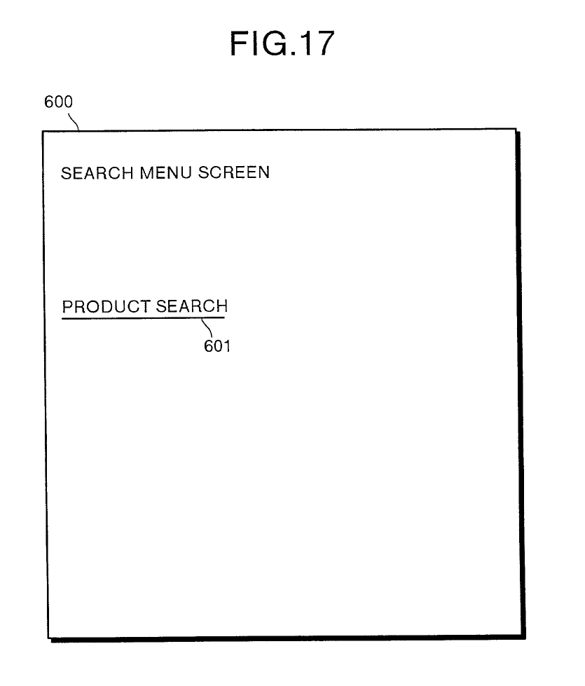

If, for example, a purchase access is made to the store server 300₁ from the consumer client 400₁, the result of the determination by the control section 302₁ of the store server 300₁ at step SG3 shown in FIG. 14 is YES. At step SG4, the control section 302₁ displays the search menu screen 600 shown in FIG. 17 on the consumer client 400₁.

At step SG5, the control section 302₁ determines whether or not a search link 601 (“product search”) in the search menu screen 600 has been clicked. In this case, if the result of the determination is NO, the same determination is repeated. If the search link 601 is clicked by a consumer, the result of the determination by the control section 302₁ at step SG5 is YES.

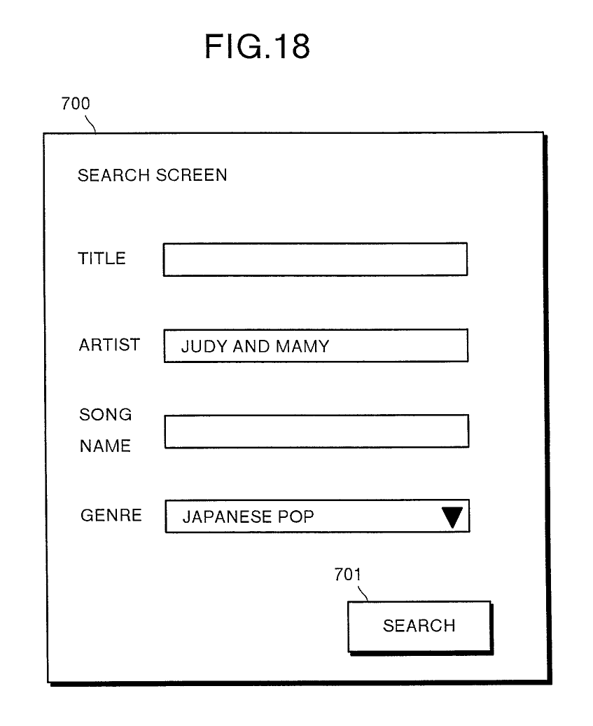

At step SG6, the control section 302₁ sends a jump request to the product catalog server 100 to jump from the store site 310₁ (i.e., from the search menu screen 600, see FIG. 17) to the product catalog site 110 (i.e., to the search screen 700: see FIG. 18). At step SG7, the control section 302₁ determines whether or not product information which verifies whether a product can be sold (described below) and a consumer identification number have been received from the product catalog server 100. In this case, the result of the determination will be taken as NO.

At step SG8, the control section 302₁ determines whether or not product information which sells a product (described below) and a consumer identification number have been received. In this case the result of the determination will be taken as NO. Thereafter, the control section 302₁ repeats the determinations of steps SG7 and SG8.

When a jump request is made at step SG6, the result of the determination at step SA3 of FIG. 8 by the control section 102 of the product catalog server 100 is YES. At step SA4, the control section 102 displays an authentication screen (not shown) on the consumer client 400₁, and then receives the input of the consumer identification number and password using this authentication screen.

At step SA5, after the control section 102 has authenticated the consumer by referring to the consumer information database (see FIG. 3) using the input consumer identification number and password as a key, it determines whether or not the result of the determination is OK. If the result of this determination is NO, the control section 102 performs the processing of step SA1 and thereafter.

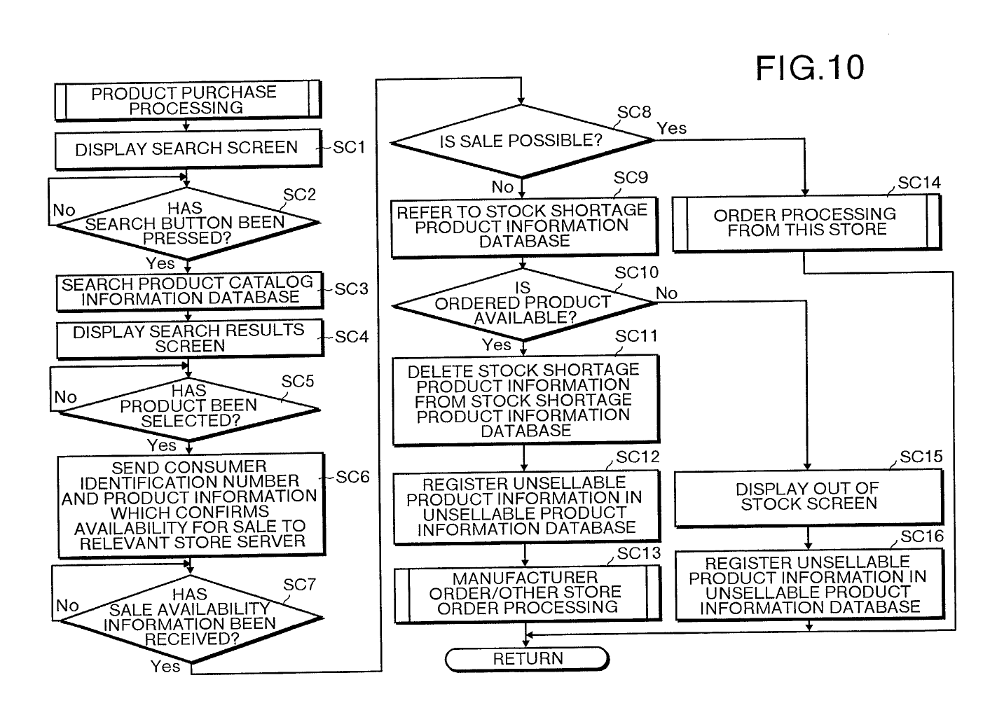

If the result of the processing at step SA5 is YES, then, at step SA6, the control section executes product purchase processing. Specifically, at step SC1 shown in FIG. 10, the control section 102 displays the search screen 700 shown in FIG. 18 on the consumer client 400₁. The search screen 700 is used to search the product catalog information database 140 (see FIG. 4) using a title, artist name, and the like as a key.

At step SC2, after a search key has been input, the control section 102 determines whether or not a search button 701 (see FIG. 18) has been pressed. If the result of the determination is NO, the same determination is repeated. After the search key has been input by the consumer, when the search button 701 is pressed, the result of the determination at step SC2 by the control section 102 is YES. At step SC3, the control section 102 searches the product catalog information database 140 (see FIG. 4).

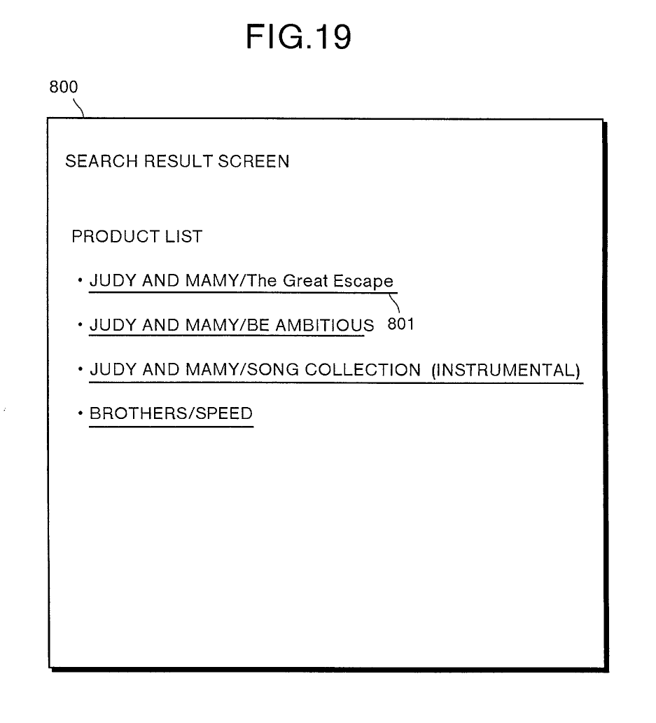

At step SC4, the control section 102 displays the search result screen 800 shown in FIG. 19 on the consumer client 400₁. A list of products is displayed on the search result screen 800 as the result of the search. At step SCS, the control section 102 determines whether or not a product to be ordered has been selected from this product list by the consumer. If the result of the determination is NO, the same determination is repeated.

When a product 801 to be ordered is selected by the consumer from the product list, the result of the determination at step SC5 by the control section 102 is YES. At step SC6, after the control section 102 has acquired product information (product identification number, product name, and the like) corresponding to the selected product 801 from the product catalog information database 140 (see FIG. 4), the control section 102 sends the product information and the consumer identification number to the store site 300₁ for verification as to whether or not this product can be sold.

At step SC7, the control section 102 determines whether or not the information on whether the product can be sold has been received by the store server 300₁. If the result of the determination is NO, the same determination is repeated.

When the product information which confirms whether the product can be sold and the consumer identification number have been received by the store server 300₁, the result of the determination at step SG7 shown in FIG. 14 by the control section 302₁ of the store server 300₁ is YES.

At step SG12, the control section 302₁ determines whether or not the product can be sold (i.e., whether or not the product is kept in stock) by its own host store (i.e., the store A) by referring to the host store sellable product information database 320₁ using the product information as a key. Note that the consumer identification number may be used to collate between the particular consumer and a blacklist managed independently by the store A. At step SG13, the control section 302₁ sends the information as to whether the product can be sold that corresponds to the determination at step SG12 to the product catalog server 100.

When the information as to whether the product can be sold is received by the product catalog server 100, the result of the determination at step SC7 shown in FIG. 10 by the control section 102 of the product catalog server 100 is YES. At step SC8, the control section 102 determines whether or not the product can be sold by the store A based on the information as to whether the product can be sold.

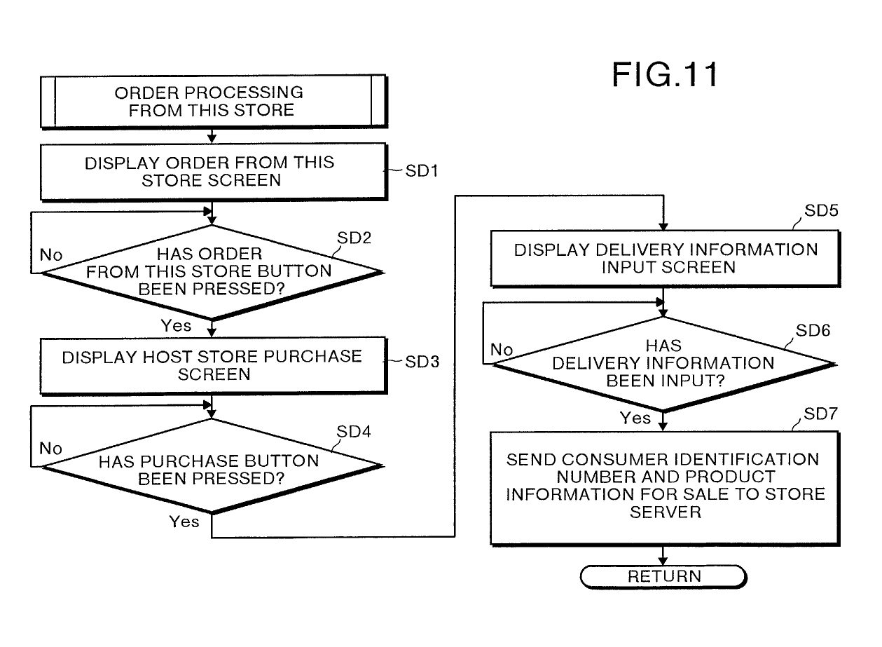

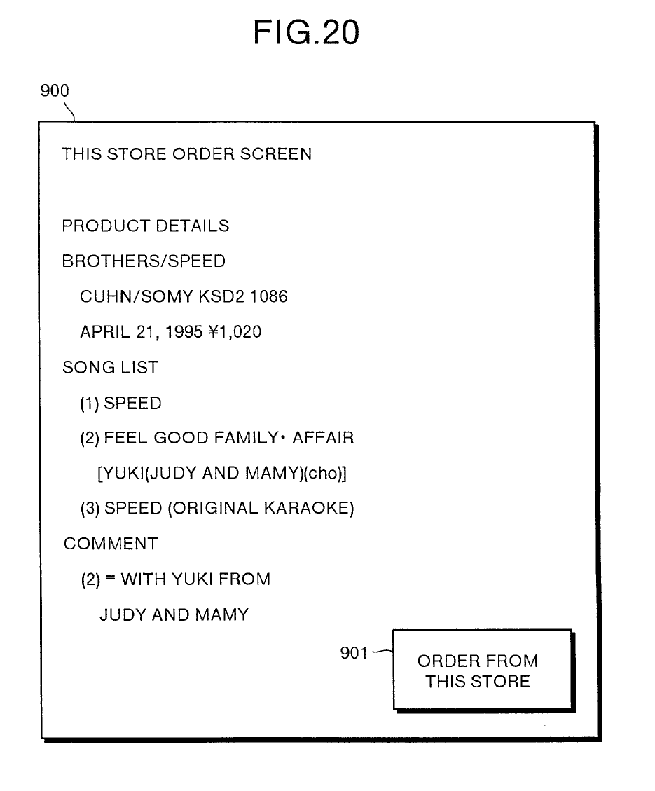

When the result of the determination at step SC8 is YES, then, at step SC14, the control section 102 executes the relevant store order processing. Specifically, at step SD1 shown in FIG. 11, the control section 102 displays a same store order screen 900, which is shown in FIG. 20, on the consumer client 400₁. This same store order screen 900 is used to receive an order for the product 801 (see FIG. 19) at the store A. In addition, detailed information on the product 801 is displayed on the same store order screen 900.

At step SD2, the control section 102 determines whether or not the same store order button 901 of the same store order screen 900 has been pressed. If the result of the determination is NO, the same determination is repeated. When the same store order button 901 is pressed by the consumer, the result of the determination of step SD2 by the control section 102 is YES.

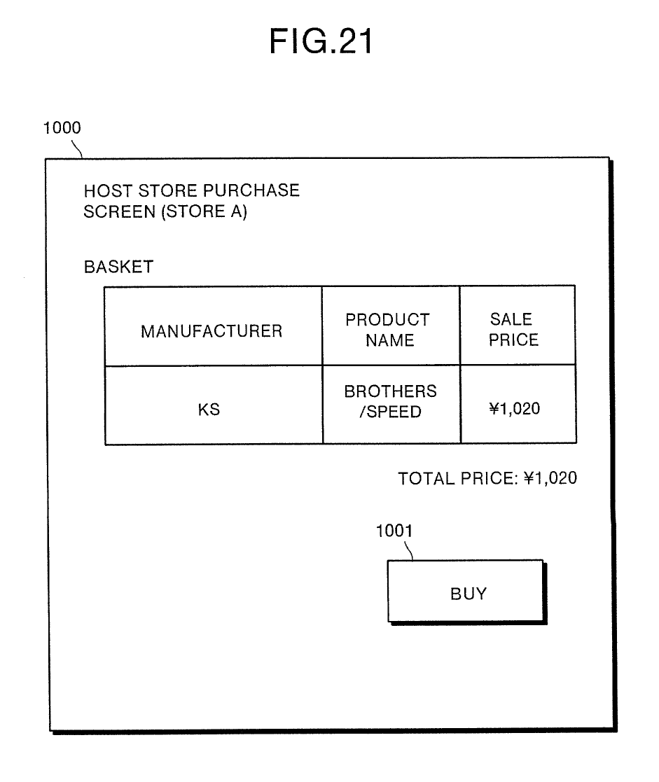

At step SD3, the control section 102 displays a host store purchase screen 1000, which is shown in FIG. 21, on the consumer client 4001. The host store purchase screen 1000 is used to purchase the product 801 (see FIG. 19) at the host store (i.e., the store A). A shopping basket, total cost, and a purchase button 1001 are displayed on the host store purchase screen 1000.

At step SD4, the control section 102 determines whether or not the purchase button 1001 has been pressed. If the result of the determination is NO, the same determination is repeated. When the purchase button 1001 is pressed by the consumer, the result of the determination of step SD4 by the control section 102 is YES.

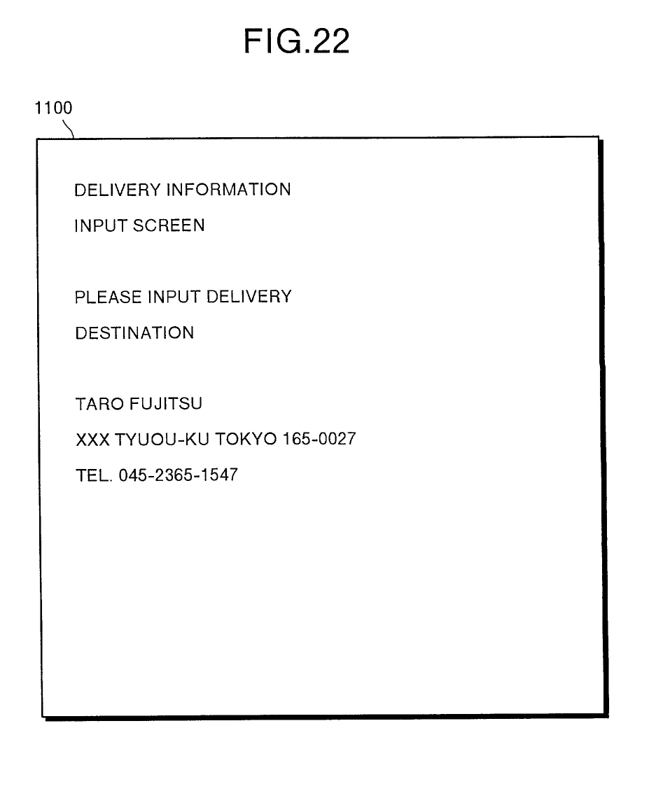

At step SD5, the control section 102 displays a delivery information input screen 1100, which is shown in FIG. 22, on the consumer client 4001. The delivery information input screen 1100 is used to receive the input by the consumer of delivery information (delivery address, telephone number, etc.) for the product 801 (see FIG. 19).

At step SD6, the control section determines whether or not the delivery information has been input. If the result of the determination is NO, the same determination is repeated. When the delivery destination information is input by the consumer, the result of the determination of step SD6 by the control section 102 is YES.

At step SD7, the control section 102 acquires product information (product identification number, product name, delivery information and the like) for the product 801 being purchased (see FIG. 19) from the product catalog information database (see FIG. 4). Thereafter, this product information and consumer identification number are sent to the store server 300₁ to be used for the sale.

When the product information and consumer identification number for the sale are received in the store server 300₁, the result of the determination at step SG8 shown in FIG. 14 by the control section 302₁ of the store server 300₁ is YES. At step SG14, after the control section 302₁ has executed sale processing (delivery, receipt of payment, and the like) in order to sell the product 801 (see FIG. 19) to the consumer based on the product information and consumer identification number, the determinations of steps SG1 and thereafter are performed.

If, however, the result of the determination at step SC8 shown in FIG. 10 is NO, namely, if the product 801 (see FIG. 19) cannot be sold by the store A (i.e., because it is not kept in stock), then, at step SC9, the control section 102 of the product catalog server 100 refers to the stock shortageproductinformationdatabase160 (see FIG. 6) using the product identification number for the product 801 as a key. Namely, at step SC9, it is confirmed whether or not the product 801 can be sold at a store other than the store A.

At step SC10, the control section 102 determines whether or not the ordered product 801 is in the stock shortage product database 160. If the result of this determination is NO, namely, if the product 801 cannot be sold by any of the stores, then, at step SC15, the control section 102 displays an out of stock screen (not shown) providing a message to the fact that the product is out of stock on the consumer client 4001.

At step SC16, the control section 102 links non-sellable product information relating to the product 801 (see FIG. 19) to the store A, and registers this non-sellable product information in the non-sellable product information database 150 (see FIG. 5).

If, however, the result of the determination at step SC10 is YES, namely, if it is possible for the product 801 (see FIG. 19) to be sold at a store other than the store A, then, at step SC11, the control section 102 deletes the stock shortage product information corresponding to the product 801 from the stock shortage product information database 160 (see FIG. 6). At step SC12, the control section 102 registers non-sellable product information relating to the product 801 in the non-sellable product information database 150 (see FIG. 5) for the store A.

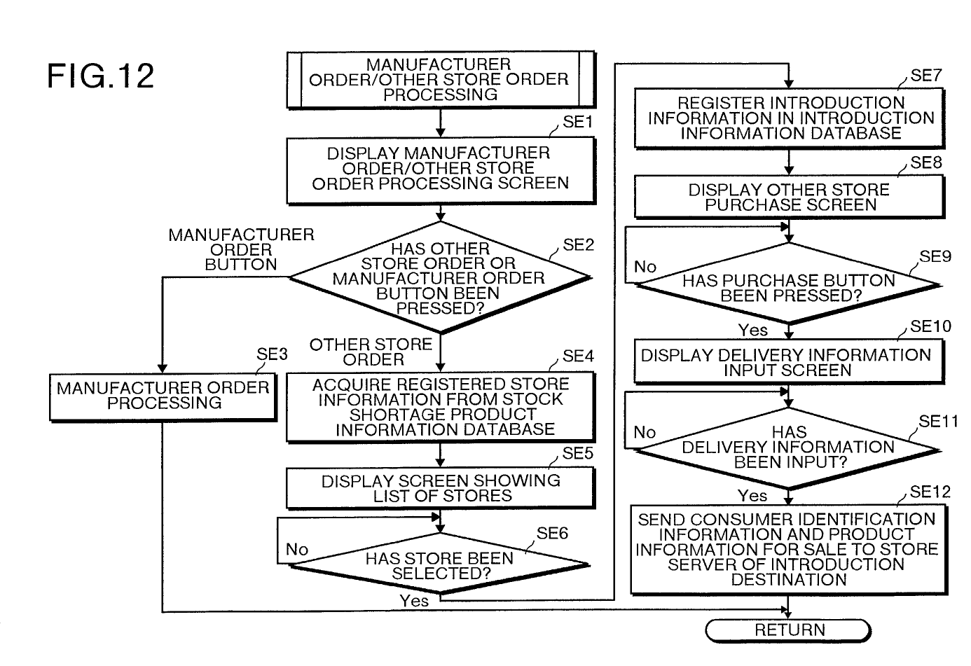

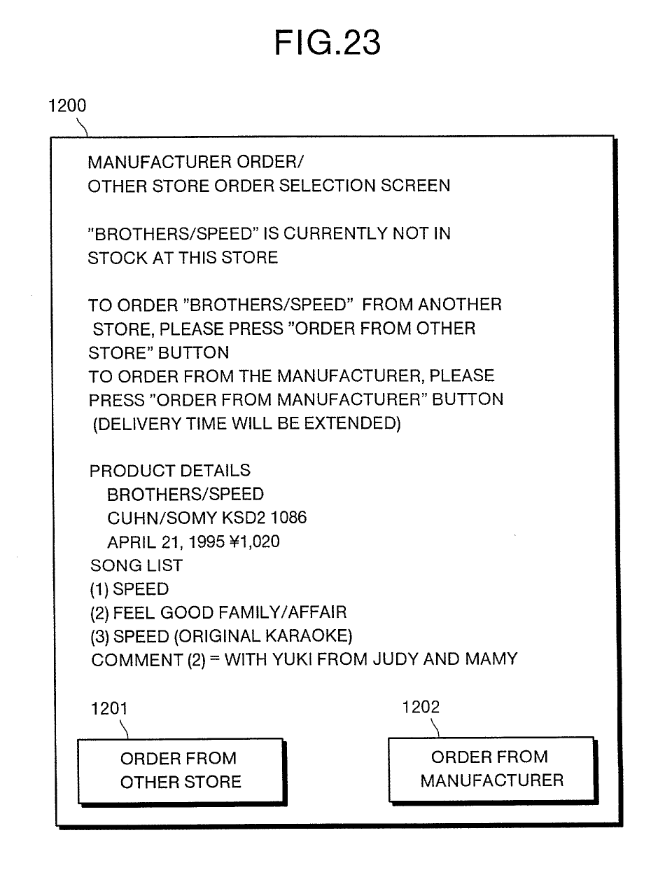

At step SC13, the control section 102 executes manufacturer order/other store order processing to either order the product 801 from the manufacturer or to order the product 801 from a store other than the store A. Specifically, at step SE1 shown in FIG. 12, the control section 102 displays a manufacturer order/other store order selection screen 1200, which is shown in FIG. 23, on the consumer client 4001.

The manufacturer order/other store order selection screen 1200 is used to have a consumer select whether the consumer wishes to order the product 801 (which is not in stock in store A) at another store that does have the product in stock or to order the product 801 directly from the manufacturer. A message to the fact that the product 801 (see FIG. 19) is out of stock and cannot be sold by the store A, detailed information about the product 801, another store order button 1201 which orders from another store, and a manufacturer order button 1202 which orders from the manufacturer.

At step SE2, the control section 102 determines whether or not the other store order button 1201 or the manufacturer order button 1202 has been pressed. Here, if the other store order button 1201 is pressed, at step SE4, the control section 102 acquires registered store information (information on other stores) that can sell the product 801 from the stock shortage product information database 160 (see FIG. 6).

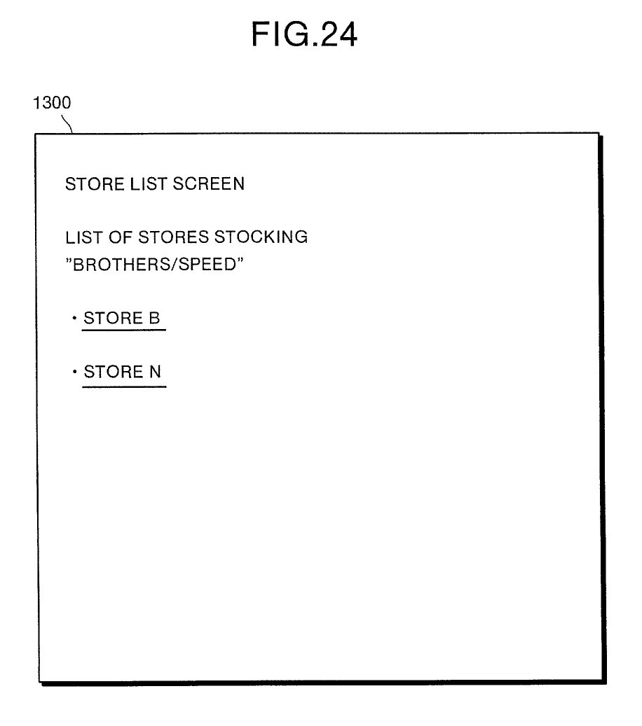

At step SE5, the control section 102 displays a store list screen 1300, which is shown in FIG. 24, on the consumer client 4001, based on the registered store information acquired at step SE4. A list of stores (store B and store N in FIG. 24) that can sell the product 801, which cannot be sold by store A, is displayed on the store list screen 1300.

At step SE6, the control section 102 determines whether or not a store which places the order has been selected by the consumer from the list of stores on the store list screen 1300. If the result of the determination is NO, the same determination is repeated. If the store N is selected by the consumer from the store list screen 1300, the result of the determination at step SE6 by the control section 102 is YES. Namely, in this case, the consumer has been introduced to the store N by the store A.

At step SE7, the control section 102 registers the introduction information relating to the introduction in the introduction information database 170 shown in FIG. 7. In this case, the introduction information consists of an introduction source store identification number corresponding to the store A, an introduction destination store identification number corresponding to the store N, a consumer identification number corresponding to the consumer ordering the product 801, and the data of the introduction.

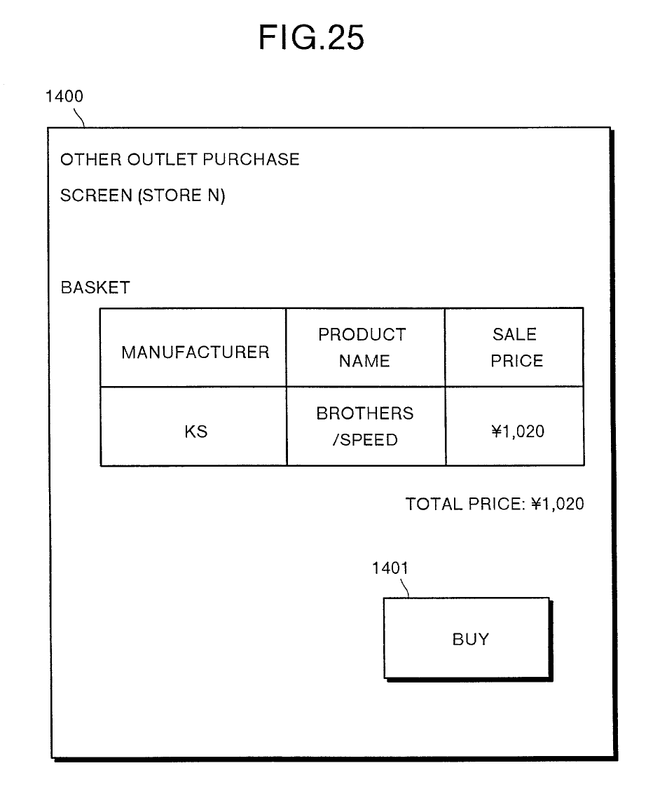

At step SE8, the control section 102 displays an other store purchase screen 1400, which is shown in FIG. 25, on the consumer client 400₁. The other store purchase screen 1400 is used to purchase the product 801 (see FIG. 19) at the other store (i.e., the store N) that is being introduced (i.e., the destination of the introduction). A shopping basket, the total cost, and a purchase button 1401 are displayed on the other store purchase screen 1400.

At step SE9, the control section 102 determines whether or not the purchase button 1401 has been pressed. If the result of the determination is NO, the same determination is repeated. When the purchase button 1401 is pressed by the consumer, the result of the determination at step SE9 by the control section 102 is YES.

At step SE10, the control section 102 displays a delivery information input screen 1100, which is shown in FIG. 22, on the consumer client 400₁. At step SE11, the control section 102 determines whether or not the delivery information has been input. If the result of the determination is NO, the same determination is repeated. When the delivery information has been input by the consumer, the result of the determination at step SE10 by the control section 102 is YES.

At step SE12, after the control section 102 has acquired product information (i.e., product identification number, product name, delivery information, and the like) corresponding to the product 801 (see FIG. 19) being purchased from the product catalog information database 140 (see FIG. 4), the control section 102 sends this product information and the consumer identification number to the store server 300ₙ of the introduction destination to be used for the sale.

When the product information and the consumer identification number for the sale are received by the store server 300ₙ, the result of the determination at step SG8 shown in FIG. 14 by the control section 302ₙ of the store server 300ₙ is YES. At step SG14, based on the product information and the consumer identification number, the control section 302₁ executes sale processing (delivery, payment receipt, and the like) to sell the product 801 (see FIG. 19) to the consumer. The determinations of step SG1 and thereafter are then repeated.

If, however, the manufacturer order button 1202 shown in FIG. 23 is pressed, then, at step SE3 shown in FIG. 12, the control section 102 executes manufacturer order processing to order the product 801 (see FIG. 19) directly from the manufacturer. Specifically, the control section 102 sends product information corresponding to the product 801 being ordered from the manufacturer as well as consumer information to the store server 300₁ corresponding to the store A.

As a result, the store server 300₁ sends detailed information on the order from the manufacturer (delivery date and the like) to the consumer client 400₁, and also sends order information to a not shown manufacturer server.

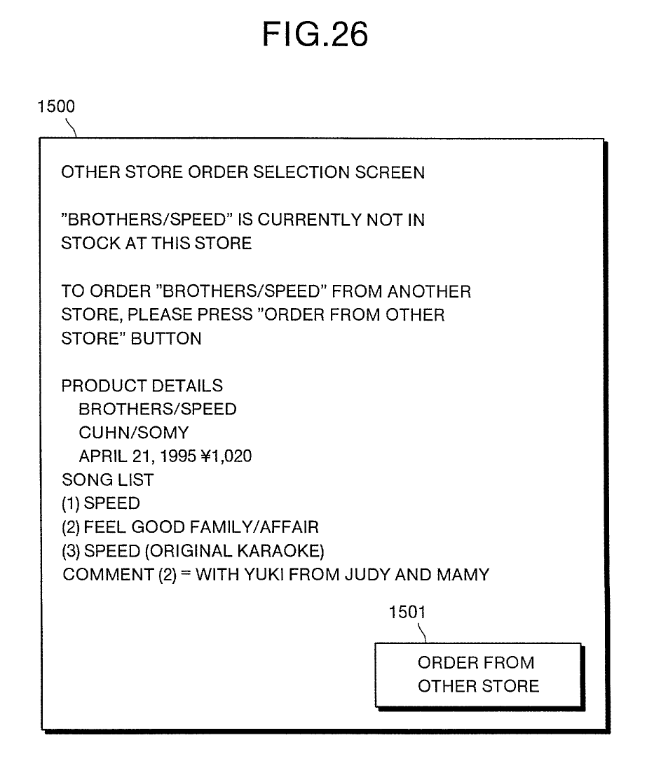

Note that, in this embodiment, instead of the manufacturer order/other store order selection screen 1200 shown in FIG. 23, it is also possible for only the other store order to be received using the other store order screen 1500 shown in FIG. 26. If the other store order button 1501 of this other store order screen 1500 is pressed, the processing of step SE4 shown in FIG. 12 and thereafter is executed.

At step SA7 shown in FIG. 8, the control section 102 of the product catalog server 100 determines whether or not a trigger (for example, an instruction from an operator) is present to trigger the processing of payment of an introduction fee that is paid by the introduction destination to the introduction source as a result of the above described introduction. If the result of the determination is NO, the determinations of step SA1 and thereafter are repeated.

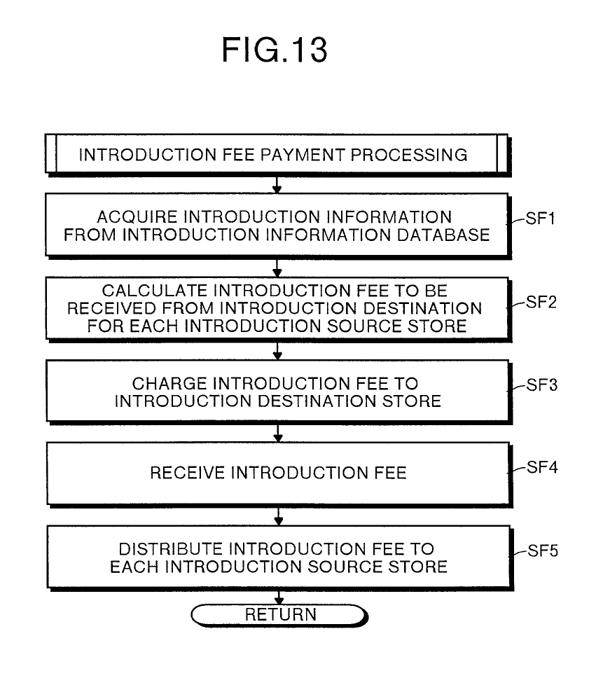

If the result of the determination at step SA7 is YES, then, at step SA10, the control section 102 executes the introduction fee payment processing. Specifically, at step SF1 shown in FIG. 13, the control section 102 acquires introduction information from the introduction information database 170 (see FIG. 7).

At step SF2, the control section 102 calculates the introduction fee to be received from the store that is the introduction destination by each of the stores that are the introduction sources. Examples of the introduction fee include a set fee for each introduction and an introduction fee that increases in proportion to the number of introductions. At step SF3, the control section 102 requests payment of the introduction fee calculated at step SF2 to each introduction destination store via electronic mail or the like.

At step SF4, the control section 102 receives as a temporary deposit the introduction fee from each introduction destination store via electronic settlement or the like. At step SF5, the control section102 distributes the introduction fee to each introduction source store by electronic settlement or the like.

As has been described above, according to this embodiment, when a product selected by a purchaser from the product catalog information database 140 cannot be sold by the store (for example, the store A) visited online by the purchaser, the purchaser is introduced to another store (for example, the store N) that can sell the product. Therefore, it is possible to avoid a situation in which a product cannot be purchased because it is not kept in stock even though the purchaser has actually tried to purchase the product, as is the instance in a conventional system. Moreover, the convenience for the purchaser is increased and sales opportunities for the stores are increased thereby creating an active marketplace.

Moreover, because the fact that a purchaser has, at the least, selected a product from the product catalog information database 140 is used as a trigger for the non-sellable product information database 150 and the stock shortage product information database 160 to be updated, maintenance of the non-sellable product information database 150 and the stock shortage product information database 160 can be carried out with ease without causing any trouble to the operator.

Furthermore, because an introduction fee is paid to the store making the introduction from the store that is being introduced, as was explained in reference to FIG. 13, cooperation between stores is strengthened, which creates an even more active and healthy marketplace.

Moreover, as is shown in FIG. 23, because either placing an order with the manufacturer or placing an order with another store is selected when the product selected by the purchaser from the product catalog (i.e., the product catalog information database 140) is unavailable for sale from the store visited by the purchaser online, the purchaser can be provided with a plurality of purchasing methods and the convenience for the purchaser thus increased even further.

It is to be understood that the specific structure is not limited to the one explained above as one embodiment. Various design modifications are possible insofar as they do not depart from the intent and purpose of the present invention.

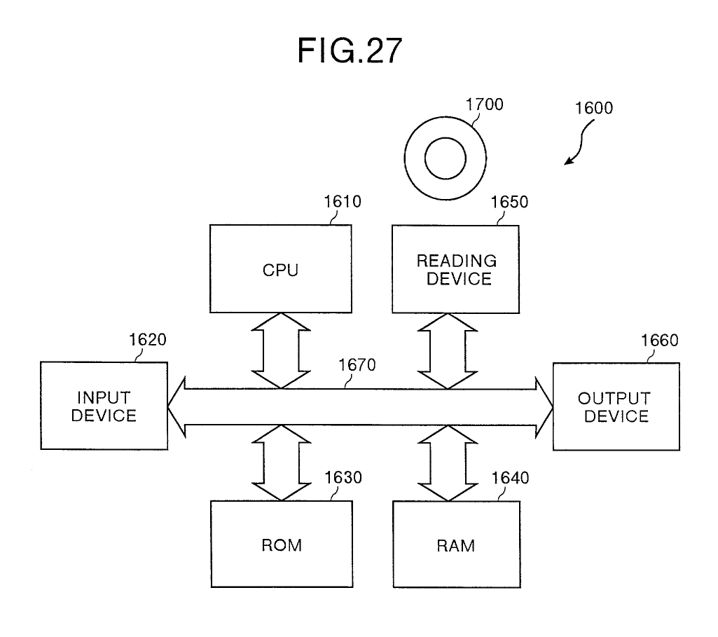

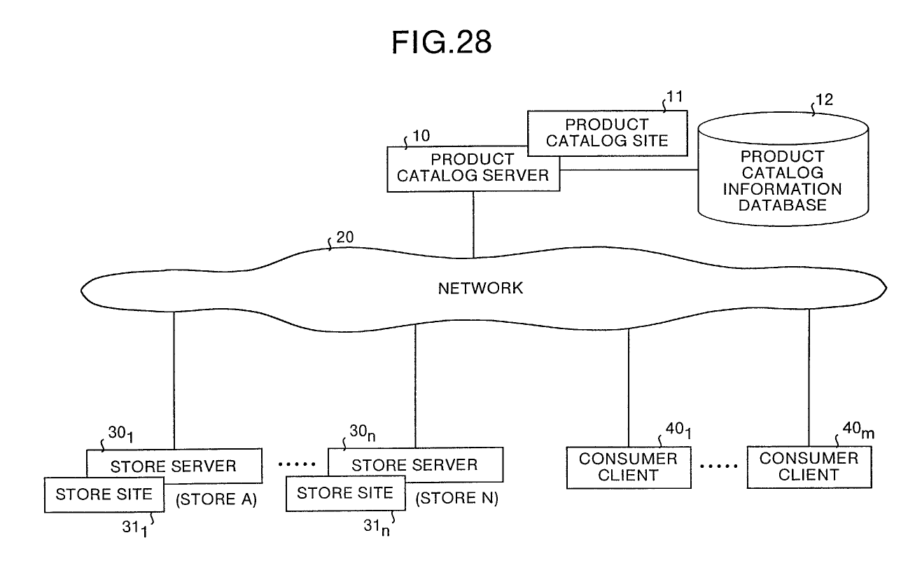

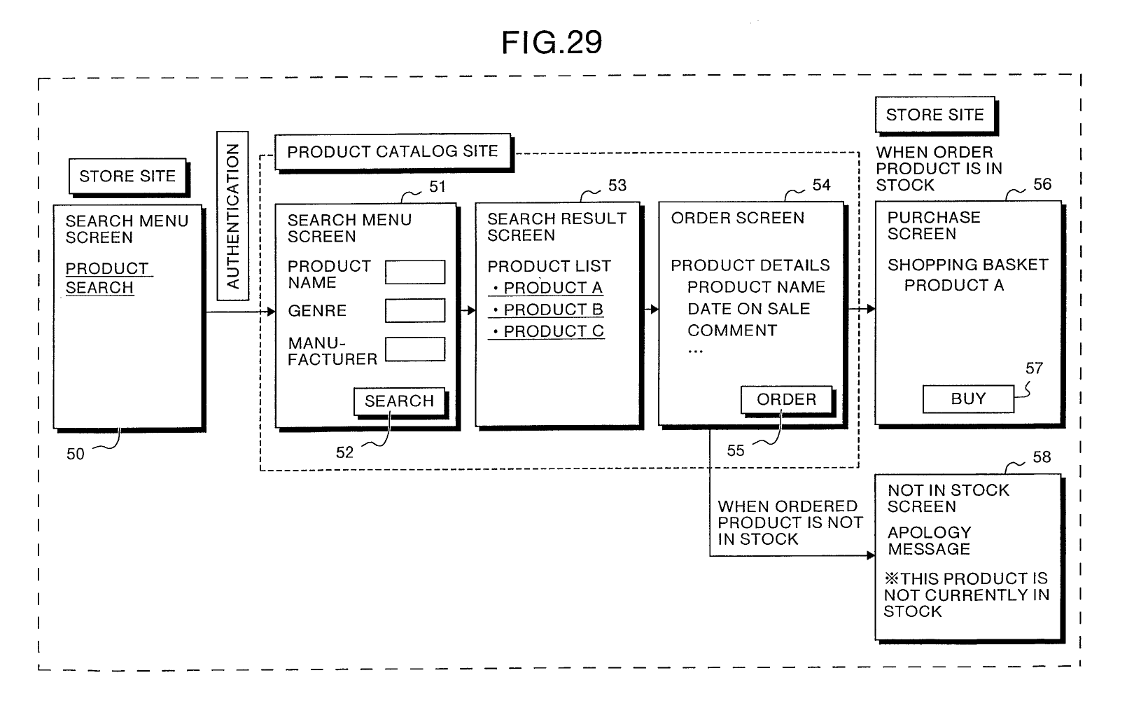

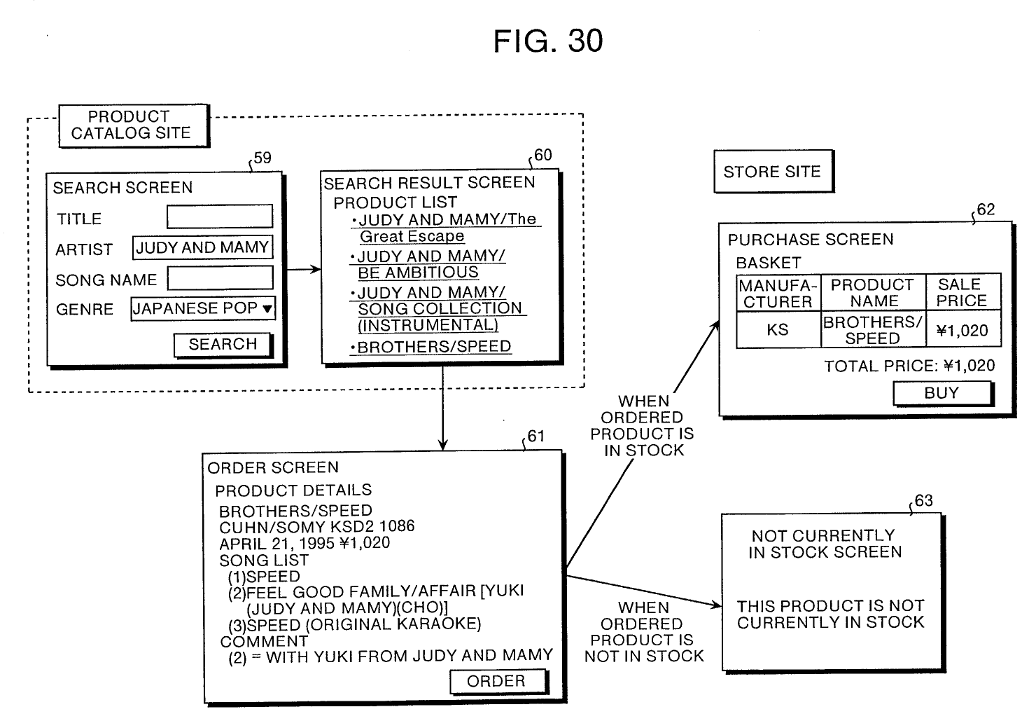

For example, a computer program which performs the functions of the product catalog server 100, the stores servers 300₁ to 300ₙ, or the consumer clients 400₁ to 400ₘ maybe recorded on a computer readable recording medium 1700, which is shown in FIG. 27. The computer program recorded on this recording medium 1700 may be read and executed by a computer 1600 to realize all the functions.

The computer 1600 is formed by a central processing unit (CPU) 1610 which executes the computer program, an input device such as a keyboard or mouse, read only memory (ROM) 1630 which stores various types of date, random access memory (RAM) 1640 which stores calculation parameters and the like, a reading device 1650 which reads a computer program from the recording medium 1700, a display unit, an output device 1660 such as a printer, and a bus 1670 which connects the respective device sections.

After reading the computer program recorded on the recording medium 1700 via the reading device 1650, the CPU 1610 executes the computer program so as to perform the functions. It is to be understood that portable recording devices such as optical disc flexible discs, and hard discs are included in the term “recording medium 1700” and, in addition, transmission mediums that temporarily record and hold data such as networks are also included.

In one embodiment, when a product is out of stock at the store A, it is possible for a new supply of the product to be received by the store A through the agency of the product catalog server 100 from the store N, which does have the product in stock. The product can then be sold via the store site 3101 of the store A.

In this case also, it is possible to avoid a situation in which a product cannot be purchased because it is not kept in stock even though the purchaser has actually tried to purchase the product, as is the instance in a conventional system. Moreover, the convenience for the purchaser is increased and sales opportunities for the stores are increased thereby creating an active marketplace.

As has been described above, according to one aspect of the present invention, it is possible to avoid a situation in which a product cannot be purchased because it is not kept in stock even though the purchaser has actually tried to purchase the product, as is the instance in a conventional system, and the convenience for the purchaser is increased and sales opportunities for the stores are increased thereby creating an active marketplace.

Moreover, because the fact that a purchaser has, at the least, selected a product from a product catalog is used as a trigger for the management information on the non-sellable product to be updated, the effect is achieved that maintenance of the management information on the non-sellable product can be carried out with ease without causing any trouble to the operator.

Furthermore, because stock shortage products, which are products that can be sold by the host store, but are out of stock at the others of a plurality of stores, are managed, and a purchaser is introduced to another store that can sell the product based on the information of the stock shortage products, the effects are achieved that it is possible to avoid a situation in which a product cannot be purchased because it is not kept in stock even though the purchaser has actually tried to purchase the product, as is the instance in a conventional system, and the convenience for the purchaser is increased and sales opportunities for the stores are increased thereby creating an active marketplace.

Moreover, because the fact that a purchaser has, at the least, selected a product from a product catalog is used as a trigger for the management information on the stock shortage product to be updated, the effect is achieved that maintenance of the management information on the stock shortage product can be carried out with ease without causing any trouble to the operator.

Furthermore, because an introduction fee is paid to the store making the introduction from the store that is being introduced, the effect is achieved that cooperation between stores is strengthened and an even more active and healthy marketplace is created.

Moreover, because either an introduction step or a step to place an order with the manufacturer is selected when the product selected by the purchaser from the product catalog is unavailable for sale from the store visited by the purchaser online, the effect is achieved that the purchaser can be provided with a plurality of purchasing methods and the convenience for the purchaser is thus increased even further.

According to still another aspect of the present invention, when a product selected by a purchaser from a product catalog cannot be sold by the store visited online by the purchaser, new shipment processing to ship anew supply of the product from the other store that does have the product in stock to the store that does not have the product in stock is executed. Therefore, the effects are achieved that it is possible to avoid a situation in which a product cannot be purchased because it is not kept in stock even though the purchaser has actually tried to purchase the product, as is the instance in a conventional system, and the convenience for the purchaser is increased and sales opportunities for the stores are increased thereby creating an active marketplace.

According to still another aspect of the present invention, because stock shortage products, which are products that can be sold by the host store, but are out of stock at the others of a plurality of stores, are managed, and a new supply of the product is shipped from the other store that does have the product in stock to the store that does not have the product in stock based on the information of the stock shortage products, the effects are achieved that it is possible to avoid a situation in which a product cannot be purchased because it is not kept in stock even though the purchaser has actually tried to purchase the product, as is the instance in a conventional system, and the convenience for the purchaser is increased and sales opportunities for the stores are increased thereby creating an active marketplace.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of selling products online by a plurality of stores based on a product catalog that comprises information on a plurality of products, the method comprising:
managing information regarding non-sellable products for each store, the non-sellable product being a product that cannot be sold at that particular store; and
when a purchaser selects a non-sellable product from the catalog of one store, introducing the purchaser to another store in which the product selected by the purchaser is a sellable product.

2. The method according to claim 1, further comprising updating the information regarding the non-sellable products for each store using selection of a product from the catalog by the purchaser as a trigger.

3. The method according to claim 1, further comprising managing information regarding stock shortage products for each store, the stock shortage product being a product that is out of stock in one particular store but that is available in another store,
wherein the purchaser is introducing to the another store based on the information regarding the stock shortage products.

4. The method according to claim 3, further comprising updating the information regarding the stock shortage products for each store using selection of a product from the catalog by the purchaser as a trigger.

5. The method according to claim 1, further comprising payment of fee by the another store to which the purchaser has been introduced to the store from whose catalog the purchaser has selected the non-sellable product.

6. The method according to claim 1, further comprising:
placing an order for the non-sellable product that has been selected by the purchaser to a manufacturer; and
selecting one step out of the step of placing the order to the manufacturer and the step of introducing the purchaser to another store.

7. A method of selling products online by a plurality of stores based on a product catalog that comprises information on a plurality of products, the method comprising:
managing information regarding non-sellable products for each store, the non-sellable product being a product that cannot be sold at that particular store; and
when a purchaser selects a non-sellable product from the catalog of one store, performing a shipment processing of shipping the product selected by the purchaser from another store in which the product selected by the purchaser is a sellable product.

8. The method according to claim 7, comprising managing information regarding stock shortage products for each store, the stock shortage product being a product that is out of stock in one particular store but that is available in another store,
wherein the product is shipped from the another store based on the information regarding the stock shortage products.

9. A computer program containing instruction for executing a method of selling products online by a plurality of stores based on a product catalog that comprises information on a plurality of products, the computer program enabling a computer to function as:
a management unit which manages information regarding non-sellable products for each store, the non-sellable product being a product that cannot be sold at that particular store; and
an introduction unit which, when a purchaser selects a non-sellable product from the catalog of one store, introduces the purchaser to another store in which the product selected by the purchaser is a sellable product.

10. A computer program containing instruction for executing a method of selling products online by a plurality of stores based on a product catalog that comprises information on a plurality of products, the computer program enabling a computer to function as:
a management unit which manages information regarding non-sellable products for each store, the non-sellable product being a product that cannot be sold at that particular store; and
a shipment unit which, when a purchaser selects a non-sellable product from the catalog of one store, performs a shipment processing of shipping the product selected by the purchaser from another store in which the product selected by the purchaser is a sellable product.
